(19) United States
(12) Patent Application Publication
(10) Pub. No.: US 2025/0041979 A1
(43) Pub. Date: Feb. 6, 2025

(54) HIGH-CAPACITY MECHANICAL LOAD TRANSFER APPARATUSES AND RELATED METHODS

(71) Applicant: COMPLETE DESIGN & INTEGRATED SOLUTIONS INC., Creemore (CA)

(72) Inventor: Robert Joseph DOUCET, Creemore (CA)

(21) Appl. No.: 18/792,894

(22) Filed: Aug. 2, 2024

Related U.S. Application Data
(60) Provisional application No. 63/517,733, filed on Aug. 4, 2023.
(60) Provisional application No. 63/613,877, filed on Dec. 22, 2023.

(51) Int. Cl. B23P 19/06

(52) U.S. Cl. CPC B23P 19/067

(57) ABSTRACT

A load transfer apparatus for transferring a structural load includes: (a) a load-bearing frame including a first plate, a second plate spaced vertically apart from the first plate and having an opening coaxial with the vertical axis, and a vertical support between and coupling the first and second plates; (b) an intermediate plate slidably mounted to the frame vertically intermediate the first and second plates for engagement with the structural load through the opening in the second plate; and (c) an integrated actuator assembly including: (i) a plurality of tension rods extending vertically between and coupling the intermediate plate and the second plate, and (ii) a plurality of mechanical tensioning actuators integrated with respective tension rods. Each tensioning actuator is operable to exert a tensioning force across a respective tension rod to pull the intermediate plate towards the second plate for transfer of the structural load through the apparatus.

### CROSS-REFERENCE TO RELATED APPLICATIONS

This application claims the benefit of U.S. Provisional Patent Application No. 63/517,733 filed Aug. 4, 2023 and U.S. Provisional Patent Application No. 63/613,877 filed Dec. 22, 2023, each of which is hereby incorporated herein by reference in its entirety.

### FIELD

The teachings disclosed herein relate generally to transfer of structural loads, and more specifically, to high-capacity, mechanical load transfer apparatuses for transfer of structural loads.

### INTRODUCTION

In certain industries (e.g. construction), it is common to require transfer of a structural load of large structures (e.g. buildings, bridges, etc.) to facilitate work on the structure or its foundation (e.g. to allow for construction, excavation, repair, inspection, etc.). Such load transfer is typically performed using hydraulic systems, usually requiring the structure to be supported by multiple devices temporarily. Hydraulic systems can often be cumbersome, and require many auxiliary systems and components including, for example, hydraulic fluids (e.g. oil), hoses, seals, motors, and/or other components required for exerting a lifting force sufficient to transfer heavy structural loads. Some hydraulic systems can further suffer from fluid leakage, and/or have slower reactive forces due to, for example, expansion of components (e.g. hoses) resulting in energy loss. Furthermore, in some cases, the structural load may need to be lifted further prior to transfer back to its initial support surface (e.g. to release a locking collar nut of a hydraulic cylinder), which may be undesirable in some cases.

### SUMMARY

The following summary is intended to introduce the reader to various aspects of the applicant's teaching, but not to define any invention.

According to some aspects, a high-capacity, mechanical load transfer apparatus for transferring a structural load of a structure includes: (a) a load-bearing housing extending along a vertical axis between a lower end positionable on a support surface for supporting the apparatus upright and an upper end vertically opposite the lower end. The housing has a generally enclosed interior extending along the vertical axis and open to the upper end of the housing through an opening coaxial with the vertical axis. The apparatus further includes (b) a ram extending along the vertical axis and slidably mounted within the interior of the housing for translation along the vertical axis between a retracted position toward the lower end of the housing and an advanced position spaced apart from the retracted position toward upper end of the housing. The ram includes a piston in the interior vertically intermediate the upper and lower ends of the housing and a ram rod projecting upwardly from the piston along the vertical axis and through the opening to a rod end above the upper end of the housing for engagement with the structure. The apparatus further includes (c) an integrated actuator assembly for translating the ram between the retracted and advanced positions. The actuator assembly includes: (i) a plurality of tension rods spaced circumferentially apart from each other about the ram rod and extending vertically between and coupling the piston and the upper end of the housing, and (ii) a plurality of mechanical tensioning actuators integrated with respective tension rods. Each tensioning actuator is operable to exert a tensioning force across a respective tension rod for pulling the piston towards the upper end of the housing, to urge the ram toward the advanced position for exerting a lifting force on the structure with the rod end to transfer the structural load to the support surface through the apparatus.

In some examples, each tensioning actuator comprises a screw actuator. In some examples, the screw actuator comprises one or more screw mechanisms. Each screw mechanism includes a first threaded component vertically fixed relative to the tension rod and in threaded engagement with a second threaded component vertically fixed relative to one of the piston and the housing. The first and second threaded components are rotatable relative to each other for exerting the tensioning force.

In some examples, each tension rod extends vertically along a respective rod axis between an upper portion of the tension rod vertically fixed relative to the upper end of the housing and a lower portion of the tension rod coupled to the piston, and each tensioning actuator is operable to urge the piston upwardly relative to the lower portion of the tension rod.

In some examples, the tensioning actuator comprises external threading along the lower portion of the tension rod in threaded engagement with internal threading fixed relative to the piston for urging the piston upwardly through rotation of the tension rod relative to the piston.

In some examples, each tensioning actuator includes a bolt head fixed to the upper portion of the tension rod and supported atop the upper end of the housing for rotating the tension rod relative to the piston.

In some examples, each tension rod extends vertically along a respective rod axis between a lower portion of the tension rod vertically fixed relative to the piston and an upper portion of the tension rod projecting above the upper end of the housing, and the tensioning actuator is operable to urge the upper portion of the tension rod upwardly relative to the upper end of the housing.

In some examples, each actuator comprises a multi-jackbolt tensioner coupling the upper portion of the tension rod to the upper end of the housing.

In some examples, the apparatus further includes a plurality of compression rods spaced circumferentially apart from each other about the vertical axis and coupled to the piston for vertical translation with the ram between the retracted and advanced positions. Each compression rod is spaced vertically apart from the lower end of the housing during translation of the ram toward the advanced position. When the ram is in the advanced position, each compression rod is movable downwardly relative to the piston into engagement with the lower end of the housing to transfer the structural load from the ram to the lower end of the housing through compression of the compression rod for unloading the tension rods.

In some examples, the ram rod extends through the opening of the housing in close sliding fit.

In some examples, the apparatus further includes an integrated load sensor system for measuring the structural load being transferred through the apparatus. In some examples, the load sensor system includes a plurality of load cells spaced equally apart from each other about the vertical axis for measuring loading at respective circumferential locations on the apparatus.

In some examples, each load cell is integrated with a respective actuator for measuring a tension load of the tension rod.

In some examples, the plurality of load cells are mounted to the housing for measuring a strain on the housing at the respective circumferential locations.

In some examples, the apparatus further includes an integrated displacement sensor system including one or more displacement sensors mounted to the apparatus for measuring a vertical displacement of the ram relative to the housing.

In some examples, the displacement sensor system includes a plurality of displacement sensors coupled between the ram and the housing and spaced equally apart from each other about the vertical axis for measuring the vertical displacement at respective circumferential locations about the ram.

According to some aspects, a high-capacity, mechanical load transfer apparatus for transferring a structural load of a structure includes: (a) a load-bearing frame extending along a vertical axis between an upper end and a lower end vertically opposite the upper end. The frame includes an upper plate at the upper end for engagement with the structure, a lower plate at the lower end and having an opening coaxial with the vertical axis for receiving a building pile through the opening, and a vertical support positioned about the opening and extending along the vertical axis between and coupling the upper and lower plates. The apparatus further includes (b) an intermediate plate slidably mounted to the frame vertically intermediate the upper and lower plates for translation along the vertical axis, the intermediate plate positionable atop the building pile when received through the opening. The apparatus further includes (c) an integrated actuator assembly for urging the lower plate upwardly toward the intermediate plate to raise the frame relative to the building pile. The actuator assembly including: (i) a plurality of tension rods spaced circumferentially apart from each other about the opening and extending vertically between and coupling the intermediate plate and the lower plate, and (ii) a plurality of mechanical tensioning actuators integrated with respective tension rods. Each tensioning actuator is operable to exert a tensioning force across a respective tension rod to pull the lower plate toward the intermediate plate, to exert a lifting force on the structure with the frame for transfer of the structural load to the building pile through the apparatus.

In some examples, the vertical support comprises a plurality of pillars spaced circumferentially apart from each other about the opening, and the intermediate plate has a plurality of apertures through which the pillars extend for slidably mounting the intermediate plate to the frame.

In some examples, each actuator comprises a multi-jackbolt tensioner coupling the tension rod to the lower plate.

According to some aspects, a high-capacity, mechanical load transfer apparatus for transferring a structural load of a structure includes (a) a load-bearing frame extending along a vertical axis between a first end and a second end. The frame includes a first plate oriented normal to the axis at the first end for engagement with one of the structure and a support surface, a second plate oriented normal to the axis at the second end and having an opening coaxial with the vertical axis, and a vertical support positioned about the opening and extending vertically between and coupling the first and second plates. The apparatus further includes (b) an intermediate plate slidably mounted to the frame vertically intermediate the first and second plates for translation along the vertical axis therebetween. The intermediate plate is for engagement with the other one of the structure and the support surface through the opening in the second plate. The apparatus further includes (c) an integrated actuator assembly for urging the intermediate plate toward the second plate. The actuator assembly including: (i) a plurality of tension rods spaced circumferentially apart from each other about the vertical axis and extending vertically between and coupling the intermediate plate and the second plate, and (ii) a plurality of mechanical tensioning actuators integrated with respective tension rods. Each tensioning actuator is operable to exert a tensioning force across a respective tension rod to pull the intermediate plate towards the second plate to exert a lifting force on the structure relative to the support surface for transfer of the structural load to the support surface through the apparatus.

In some examples, each tensioning actuator comprises a screw actuator. In some examples, the screw actuator comprises one or more screw mechanisms. Each screw mechanism includes a first threaded component vertically fixed relative to the tension rod and in threaded engagement with a second threaded component vertically fixed relative to one of the intermediate plate and the frame. The first and second threaded components are rotatable relative to each other for exerting the tensioning force.

In some examples, the tensioning actuator comprises external threading extending about and along the tension rod. The external threading is in threaded engagement with internal threading fixed relative to the intermediate plate for urging the intermediate plate toward the second plate through rotation of the tension rod relative to the intermediate plate.

In some examples, each actuator comprises a multi-jackbolt tensioner coupling the tension rod to the second plate.

In some examples, the apparatus further includes a plurality of compression rods spaced circumferentially apart from each other about the vertical axis and coupled to the intermediate plate. Each compression rod is translatable along the vertical axis relative to the intermediate plate for engagement with the first plate to transfer the structural load from the intermediate plate to the first plate through compression of the compression rod for unloading the tension rods.

In some examples, the apparatus further includes a ram rod vertically fixed to and projecting vertically from the intermediate plate through the opening to a rod end for engagement with the other one of the structure and the support surface.

In some examples, the frame comprises a housing, and the vertical support comprises a sidewall horizontally enclosing an interior of the housing containing the intermediate plate.

In some examples, the intermediate plate is positionable atop a building pile receivable through the opening.

In some examples, the vertical support comprises a plurality of pillars spaced circumferentially about the vertical axis and to which the intermediate plate is slidably mounted.

In some examples, the apparatus includes an integrated load sensor system for measuring the structural load being transferred through the apparatus, the load sensor system including a plurality of load cells spaced equally apart from each other about the vertical axis for measuring loading at respective circumferential locations on the apparatus.

In some examples, each load cell is integrated with a respective actuator for measuring a tension load of the tension rod.

In some examples, the plurality of load cells are mounted to the frame for measuring a strain on the frame at the respective circumferential locations.

In some examples, the apparatus further includes an integrated displacement sensor system including one or more displacement sensors for measuring a vertical displacement of the intermediate plate relative to the frame. The displacement sensor system includes a plurality of displacement sensors spaced equally apart from each other about the vertical axis for measuring the vertical displacement at respective circumferential locations on the apparatus.

A high-capacity, mechanical load transfer apparatus for transferring a structural load of a structure, includes: (a) a base positionable on a support surface for supporting the apparatus upright; (b) a ram supported by the base and projecting upwardly relative to the base along a vertical axis to an upper end of the ram for engagement with the structure; and (c) an integrated actuator assembly coupling the ram to the base and operable to urge the ram upwardly relative to the base along the vertical axis to exert a lifting force for transferring the structural load to the support surface through the apparatus. The actuator assembly includes a plurality of rods spaced circumferentially apart from each other about the vertical axis and coupling the ram to the base for transfer of the structural load from the ram to the base through the plurality of rods, and a plurality of mechanical actuators integrated with respective rods, each actuator operable independently of each other actuator for sequentially loading respective rods one-by-one in a plurality of actuation cycles to incrementally urge the ram upwardly.

In some examples, each actuator is operable to urge the ram upwardly along a respective rod. In some examples, each mechanical actuator comprises a screw actuator.

In some examples, the ram includes a ram rod projecting upwardly from the base along the vertical axis to the upper end of the ram and a flange fixed to and projecting radially from the ram rod below the upper end of the ram, and wherein the plurality of rods extend vertically between and couple the flange and the base.

In some examples, the flange includes a plurality of apertures spaced circumferentially apart from each other about the vertical axis and extending vertically through the flange, and wherein the plurality of rods extend vertically through respective apertures. In some examples, each actuator comprises external threading extending about a respective rod and in engagement with internal threading in a respective aperture. In some examples, each rod extends vertically through a respective aperture along a respective rod axis between an upper portion above the flange and a lower portion below the flange and supported by the base, the upper portion comprising a bolt head for torquing the rod about the rod axis relative to the flange to load the rod for urging the ram upwardly along the rod.

In some examples, the base has a bore extending along the vertical axis below the actuator assembly, the bore receiving a lower end of the ram in close sliding fit. In some examples, the base comprises a base plate and at least one extension plate removably mountable between the base plate and the actuator assembly for adjusting a height of the upper end of the ram relative to the base plate.

In some examples, each extension plate comprises a plurality of plate sections spaced circumferentially apart from each other about the ram, each plate section insertable and removable from vertically between the base plate and a bottom end of a set of respective rods of the plurality of rods when the set of rods are raised out of engagement with the base while the remaining rods of the plurality of rods remain lowered into engagement with the base.

In some examples, the apparatus further includes an integrated load sensor system for measuring the structural load being transferred through the apparatus. In some examples, the integrated load sensor system comprises a load cell integrated with the ram.

In some examples, the actuator assembly comprises at least nine rods and respective actuators.

According to some aspects, a method of transferring a structural load of a structure using a mechanical load transfer apparatus includes: (a) positioning the apparatus between the structure and a support surface, with a base of the apparatus positioned on the support surface and an upper end of a ram of the apparatus positioned adjacent the structure; and (b) operating an integrated actuator assembly of the apparatus to urge the ram upwardly relative to the base to engage the structure and transfer the structural load to the support surface through the apparatus. Operating the actuator assembly includes actuating a plurality of mechanical actuators of the actuator assembly independently of each other to sequentially load a plurality of respective rods coupling the ram and the base one-by-one in a plurality of actuation cycles for incrementally urging the ram upwardly.

### BRIEF DESCRIPTION OF DRAWINGS

For a better understanding of the described examples and to show more clearly how they may be carried into effect, reference will now be made, by way of example, to the accompanying drawings in which:

FIG. 1 is a side elevation schematic of an example load transfer apparatus shown positioned between a structure and a support surface below the structure;

FIG. 2 is a perspective view of the apparatus of FIG. 1;

FIG. 3 is an exploded perspective view of an apparatus like that of FIG. 1;

FIG. 4 is a side elevation cross-sectional view of the apparatus of FIG. 3;

FIG. 5A is a cross-sectional schematic of a portion of the apparatus of FIG. 4, showing a ram of the apparatus in a retracted position;

FIG. 5B is a schematic like that of FIG. 5A but showing the ram in an advanced position;

FIG. 5C is a schematic like that of FIG. 5B, but showing a rod of the apparatus lowered relative to the ram;

FIG. 6 is a perspective view of another example load transfer apparatus;

FIG. 7 is an exploded perspective view of an apparatus like that of FIG. 6;

FIG. 8 is a side elevation cross-sectional view of the apparatus of FIG. 7;

FIG. 9A is a cross-sectional schematic of a portion of the apparatus of FIG. 8, showing a ram of the apparatus in a retracted position;

FIG. 9B is a schematic like that of FIG. 9A, but showing the ram in an advanced position;

FIG. 9C is a schematic like that of FIG. 9B, but showing a rod of the apparatus lowered relative to the ram;

FIG. 10 is a bottom perspective view of another example load transfer apparatus;

FIG. 11 is a top exploded perspective view of the apparatus of FIG. 10;

FIG. 12 is a side elevation cross-sectional view of the apparatus of FIG. 10;

FIG. 13A is a side schematic of the apparatus of FIG. 10, showing the apparatus between a building pile and a structure and with a frame of the apparatus in a lowered position (and an intermediate plate in a retracted position relative to the frame);

FIG. 13B is a side schematic like that of FIG. 13A, but showing the frame in a raised position (and the intermediate plate in an advanced position relative to the frame);

FIG. 14 is a perspective view of another example load transfer apparatus;

FIG. 15 is a side elevation cross-sectional view of the apparatus of FIG. 14, showing a ram of the apparatus in a retracted position;

FIG. 16 is a side elevation cross-sectional view like that of FIG. 15, showing the ram of the apparatus in an advanced position;

FIG. 17 is a side elevation cross-sectional view like that of FIG. 15, with one extension plate of the apparatus removed; and

FIG. 18 is a side elevation cross-sectional view like that of FIG. 15, with all extension plates of the apparatus removed.

### DESCRIPTION OF VARIOUS EXAMPLES

Various apparatuses or processes will be described below to provide an example of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an example of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

According to some aspects of the present teachings, mechanical load transfer apparatuses configured to transfer structural loads are disclosed, which can address some of the shortcomings of hydraulic or other types of load transfer systems. The load transfer apparatuses of the present teachings can have a relatively high load capacity, for example, in excess of twenty-five tons. In some examples, the load capacity can be in the hundreds of tons (e.g. in excess of 400 tons). The load transfer apparatuses of the present teachings are mechanical in operation, in that the mechanisms for load transfer operate through engagement between solid mechanical components, without reliance on hydraulic fluid pressure.

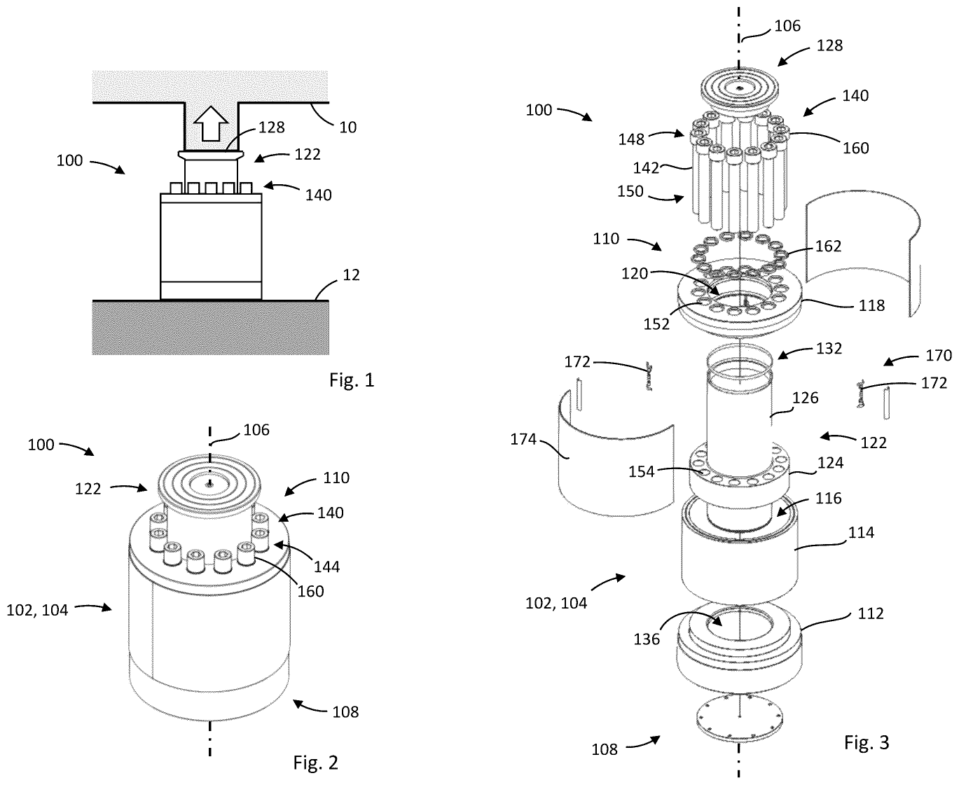

Referring to FIG. 1, an example high-capacity, mechanical load transfer apparatus 100 for transferring a structural load of a structure 10 (e.g. building, bridge, etc.) to a support surface 12 (e.g. ground, foundation, etc.) is shown schematically. Referring to FIG. 2, in the example illustrated, the apparatus 100 includes a load-bearing frame 102 extending along a vertical axis 106 between a first end 108 and a second end 110 vertically opposite the first end 108. The frame 102 defines a base of the apparatus 100. In the example illustrated, when the frame 102 is upright, the first end 108 comprises a lower end of the frame 102 and the second end 110 comprises an upper end of the frame 102 above the lower end 108.

Referring to FIG. 3, in the example illustrated, the frame 102 has a first plate 112 at the first, lower end 108 for supporting the apparatus 100 upright, a vertical support 114 extending upwardly from the first plate 112 along the vertical axis 106, and a second plate 118 supported by the vertical support 114 at the second, upper end 110 of the housing 104. In the example illustrated, the first and second plates 112, 118 are oriented generally normal to the vertical axis 106, and are coupled to and spaced vertically apart from each other through the vertical support 114.

In the example illustrated, the frame 102 comprises a housing 104 having a generally enclosed interior 116. In the example illustrated, the first plate 112 (also referred to as base plate 112) of the housing 104 positionable on the support surface 12 for supporting the apparatus 100 upright, the second plate 118 defines a top wall of the housing 104, and the vertical support 114 defines a sidewall horizontally enclosing the interior 116 of the housing 104. In the example illustrated, the top wall 118 of the housing 104 extends radially inwardly from the sidewall 114 overtop of the interior 116 to an opening 120 passing through the top wall 118 coaxial with the vertical axis 106. In the example illustrated, the sidewall 114 is positioned about the opening 120, and comprises a cylindrical barrel extending along and coaxial with the vertical axis 106.

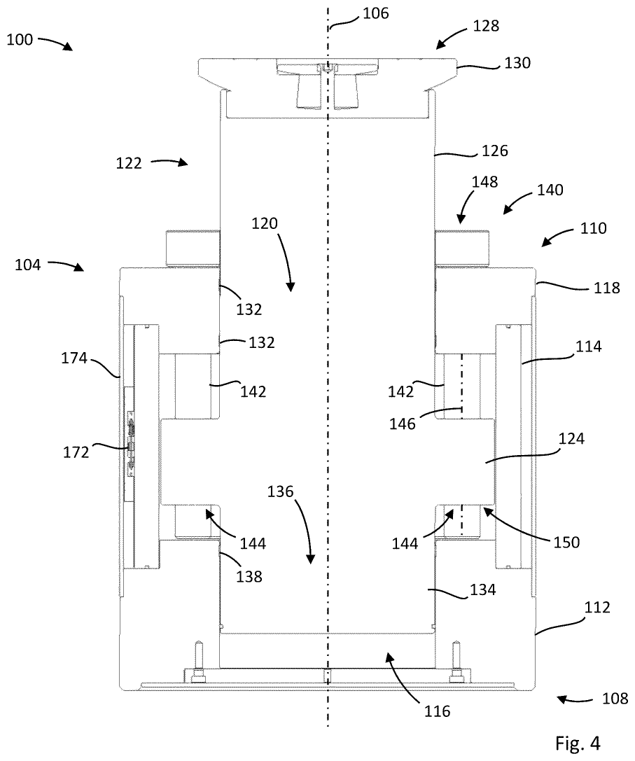

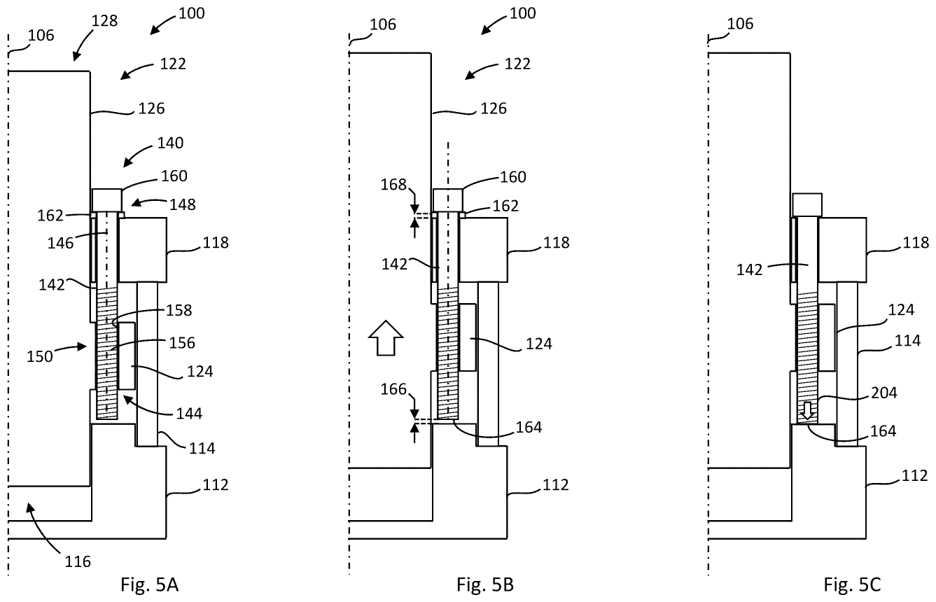

Referring to FIG. 4, in the example illustrated, the apparatus 100 includes a ram 122 extending along the vertical axis 106. In the example illustrated, the ram 122 is supported by the housing/base 102 (through the actuator assembly 140, in the example illustrated). In the example illustrated, the ram 122 is slidably mounted to the housing 104. In the example illustrated, the ram 122 is slidably received within the interior 116 of the housing 104 for translation along the vertical axis 106. Referring to FIGS. 5A and 5B, the ram 122 is translatable along the vertical axis 106 between a retracted position (FIG. 5A) toward the base plate 112 of the housing 104 and an advanced position (FIG. 5B) spaced apart from the retracted position toward the top wall 118 of the housing 104. In the example illustrated, the ram 122 has a flange 124 (also referred to as intermediate plate 124) and a ram rod 126. The flange 124 is fixed to and projects radially from the ram rod 126 below the upper end 128 of the ram 122. In the example illustrated, the flange 124 is in the form of a piston in the interior 116 vertically intermediate the base plate 112 and top wall 118 of the housing 104 for translation therebetween along the vertical axis 106. The piston 124 is positioned toward the base plate 112 of the housing when the ram 122 is in the retracted position. When the ram 122 is moved toward the advanced position, the piston 124 is moved away from the base plate 112 toward the top wall 118 of the housing. In the example illustrated, the piston 124 is generally cylindrical, and positioned in the interior 116 of the housing 104 in close fit with the sidewall 114 and in alignment with (under) the top wall 118.

In the example illustrated, the ram rod 126 projects upwardly from the piston 124 along the vertical axis 106 through the opening 120 to the upper end 128 of the ram 122 above the housing 104 for engagement with the structure (either directly, or indirectly through, for example, one or more shims, wedges, washers etc.). The upper end 128 is lowered toward the housing 104 when the ram 122 is in the retracted position to facilitate positioning of the apparatus 100 between the support surface 12 and the structure 10. When the ram 122 is moved toward the advanced position, the upper end 128 is raised upwardly away from the housing 104 relative to the retracted position for bearing (directly or indirectly) against the structure to exert a lifting force on the structure.

Referring to FIG. 4, in the example illustrated, the upper end 128 of the ram 122 comprises a swivel plate 130 rotatably mounted atop the ram rod 126 coaxial with and rotatable about the vertical axis 106 to facilitate engagement of the upper end 128 with the structure 10. In the example illustrated, the ram rod 126 extends through the opening 120 of the top wall 118 in close sliding fit. One or more top wall bushings 132 are mounted in the opening 120 for sliding engagement with the ram rod 126 to facilitate the close sliding fit and alignment of the ram rod 126 with the vertical axis 106. In the example illustrated, the one or more bushings 132 include a pair of sleeve bearings spaced vertically apart from each other, and mounted in respective circumferential grooves formed in a radially inner surface of the opening 120.

In the example illustrated, the ram 122 further includes a guide shaft 134 projecting downwardly from the piston 124 opposite and coaxial with the ram rod 126, and defining a lower end of the ram 122. In the example illustrated, the base plate 112 of the housing 104 has a bore 136 extending along the vertical axis 106 and open to an upper surface of the base plate 112 directed toward the piston 124. The bore 136 defines a bottom end of the interior 116 of the housing 104 and receives the guide shaft 134 in close sliding fit. This can help guide vertical translation, facilitate alignment, and increase side loading capacity of the ram 122. In the example illustrated, at least one base plate bushing 138 (e.g. a sleeve bearing) is mounted in the bore 136 for sliding engagement with the guide shaft 134 to facilitate the close sliding fit.

In the example illustrated, the piston 124, ram rod 126, and guide shaft 134 are of integral, unitary, one-piece construction, and can be formed integrally in, for example, a machining or casting process. In other examples, the piston can be manufactured separately and coupled to the ram rod 126 and guide shaft 134 to assemble the ram 122 (e.g. through threaded engagement between internal threading in a central opening of the piston and external threading on a integrally formed shaft defining the ram rod 126 and guide shaft 134).

In the example illustrated, the apparatus 100 further includes an integrated actuator assembly 140 for translating the ram 122 between the retracted and advanced positions. In the example illustrated, the actuator assembly 140 couples the ram 122 to the housing 102. In the example illustrated, the actuator assembly 140 includes a plurality of actuator rods. In the example illustrated, the rods comprise a plurality of tension rods 142 (which can also be referred to as tie rods or tie bars 142) spaced circumferentially apart from each other about the ram rod 126 and extending vertically between and coupling the piston 124 and the top wall 118. In the example illustrated, the actuator assembly 140 further includes a plurality of mechanical (non-hydraulic) actuators integrated with respective tension rods 142. In the example illustrated, the plurality of mechanical actuators comprises a plurality of mechanical tensioning actuators 144. Each tensioning actuator 144 is independently operable to sequentially load (e.g. exert a tensioning force across) a respective tension rod 142 for pulling the piston 124 towards the top wall 118, to urge the ram 122 toward the advanced position for exerting the lifting force on the structure 10 with the upper end 128 of the ram 122 to transfer the structural load to the support surface 12 through the apparatus 100. In the example illustrated, when being transferred through the apparatus 100, the structural load is borne by the ram 122, the tension rods 142, and the housing 104. The structural load is transferred from the ram 122 to the top wall 118 through the tension rods 142, which are under tension, and from the top wall 118 to the base plate 112 through the sidewall 114, which is under compression.

In the example illustrated, the plurality of tension rods 142 are spaced equally apart from each other about the ram rod 126 (and vertical axis 106). The actuator assembly 140 can include at least three tension rods 142 to facilitate alignment and balanced distribution of the actuator forces about the vertical axis 106. In some examples, the actuator assembly can include at least five, nine, twelve, or fourteen tension rods 142 to facilitate load distribution among the rods, and which can help reduce the required actuation force for each actuator. In the example illustrated in FIG. 3, the actuator assembly 140 includes fourteen tension rods 142. Referring to FIG. 5A, in the example illustrated, each tension rod 142 extends vertically along a respective rod axis 146. The rod axes 146 extend parallel with the vertical axis 106. Each tension rod 142 extends vertically along the rod axis 146 through the top wall 118, between an upper portion 148 of the tension rod 142 projecting upwardly from and supported above the top wall 118 and a lower portion 150 of the tension rod 142 coupled to the piston 124.

Referring to FIG. 3, in the example illustrated, the top wall 118 has a plurality of top wall apertures 152 extending through the top wall 118 parallel with the vertical axis 106. Each top wall aperture 152 extends vertically between an underside of the top wall 118 facing the interior 116 (and the piston 124) and a topside of the top wall 118 opposite the underside and directed toward the structure 10. The plurality of top wall apertures 152 are radially outward of, and spaced circumferentially apart from each other about, the opening 120 of the top wall 118. In the example illustrated, the quantity of top wall apertures 152 is equal to the quantity of tension rods 142. In the example illustrated, the piston 124 has a plurality of piston apertures 154 extending through the piston 124 parallel with the vertical axis 106 and in horizontal alignment with respective top wall apertures 152. The quantity of piston apertures 154 is equal to the quantity of top wall apertures 152. In the example illustrated, each tension rod 142 extends through a respective top wall aperture 152 for positioning the upper portion 148 of the tension rod 142 above the top wall 118, and through a respective piston aperture 154 for coupling the lower portion 150 of the tension rod 142 to the piston 124.

In the example illustrated, the upper portion 148 of each tension rod 142 is vertically fixed relative to the top wall 118 in use, and each tensioning actuator 144 is operable to urge the piston 124 upwardly relative to the lower portion 150 of the tension rod 142 for exerting the tensioning force across the tension rod 142. In the example illustrated, each tensioning actuator 144 is screw operated. In the example illustrated, each tensioning actuator 144 comprises a screw actuator having a screw mechanism for exerting the tensioning force. Referring to FIG. 5A, in the example illustrated, the screw mechanism comprises a first threaded component 156 vertically fixed relative to the tension rod 142 and in threaded engagement with and rotatable relative to a second threaded component 158 vertically fixed relative to the piston.

Referring still to FIG. 5A, in the example illustrated, each tension rod 142 and respective actuator 144 form a tensioning bolt, with the first threaded component 156 comprising external threading extending about the rod axis 146 along the lower portion 150 of the tension rod 142. The second threaded component 158 comprises internal threading fixed relative to the piston 124 and in threaded engagement with the external threading 156 for urging the piston 124 upwardly through rotation of the tension rod 142 about the rod axis 146 relative to the piston 124. In the example illustrated, the internal threading 158 is formed integrally on a radially inner surface of the piston aperture 154. In the example illustrated, a bolt head 160 is fixed at the upper portion 148 of the tension rod 142 and supported atop the top wall 118 for rotating (e.g. torquing) the tension rod 142 relative to the piston 124. In the example illustrated, the bolt head 160 is supported atop the top wall 118 by a spacer 162 positioned vertically between the bolt head 160 and the top wall 118.

Referring to FIG. 5B, during actuation, a bottom end 164 of each tension rod 142 is spaced above the base plate 112 by a vertical clearance 166 to transfer loading from the ram 122 to the top wall 118 through tensioning of a tension portion of the tension rod 142 extending between the bolt head 160 and the piston 124. In the example illustrated, the vertical clearance 166 is less than a vertical thickness 168 of the spacer 162. Referring to FIG. 5C, this can allow for the bottom end 164 of the tension rod 142 to be lowered into engagement with the housing base plate 112 through removal of the spacer 162, and transfer of loading from the ram 122 to the housing base plate 112 through compression of a compression portion of the rod 142 extending between the piston 124 and the base plate 112 for unloading the top wall 118 and sidewall 114. The compression portion extending between the piston 124 and the base plate 112 serves as a compression rod 204 formed integrally with the tension portion of the tension rod 142.

Referring to FIG. 5B, in the example illustrated, the spacer 162 comprises a washer extending about the tension rod 142 and positioned vertically between the bolt head 160 and the top wall 118. The washer can comprise, for example, a split washer to permit removal of the washer while the tension rod 142 remains in threaded engagement with the piston 124 (e.g. by partially unscrewing the tension rod 142 from the piston 124 to raise and disengage the bolt head 160 from the washer).

Referring to FIG. 3, in the example illustrated, the apparatus 100 further includes an integrated load sensor system 170 for measuring the structural load being transferred through the apparatus 100. In the example illustrated, the load sensor system 170 includes a plurality of load cells 172 (three load cells 172, in the example illustrated) spaced equally apart from each other about the vertical axis 106 for measuring loading at respective circumferential locations on the apparatus 100 for determining the structural load. In some examples, this can allow for measurement of a load differential between respective load cells 172 (at the respective circumferential locations) and detection and/or determination of load imbalance about the vertical axis 106 (e.g. due to uneven tensioning and/or load distribution among the tension rods 142) and/or side loading exerted on the apparatus 100 based on the load differential.

Referring to FIG. 4, in the example illustrated, the plurality of load cells 172 are mounted to the sidewall 114 for measuring loading on the sidewall 114 at the respective circumferential locations, which are in vertical and radial alignment and spaced equally apart from each other about the axis 106. In the example illustrated, each load cell 172 comprises a strain gauge for measuring compressive strain on the sidewall 114 at a respective circumferential location. In the example illustrated, the load cells 172 are mounted on a radially outer surface of the sidewall 114. In the example illustrated, the apparatus 100 further includes a removable casing 174 extending vertically between the housing base plate 112 and top wall 118 and circumferentially about the sidewall 114 for covering the sidewall 114 and the load cells 172. The casing 174 is removable for accessing the load cells 172 (e.g. for maintenance, replacement, etc.).

In addition or alternatively, in some examples, load cells can be integrated with respective actuators 144 for measuring loading on respective tension rods 142. For example, the load cells can be integrated with the spacers under the bolt head 160 (e.g. in the form of piezoelectric load cells) for measuring compressive loading exerted on the spacer by the bolt head 160 (which can be indicative of loading on the tension rods).

Referring to FIG. 1, in operation, the apparatus 100 is positioned between the support surface 12 and the structure 10 with the ram 122 in the lowered position. Optionally, one or more shims or other load-bearing spacers can be positioned between the upper end 128 of the ram 122 and the structure 10 to take up any excess spacing therebetween. When the apparatus 100 is in position, the actuator assembly 140 is operated to urge the ram 122 upwardly toward the advanced position to exert a lifting force on the structure 10 for transfer of the structural load to the support surface 12 through the apparatus 100.

Referring to FIGS. 2 and 3, in the example illustrated, operating the actuator assembly 140 includes actuating the plurality of tensioning actuators 144 one at a time sequentially during an initial actuation cycle, and then repeating the actuation cycle a plurality of times to incrementally raise the ram 122 with each actuation cycle until the structural load is taken up by the apparatus 100. In the example illustrated, each tensioning actuator 144 is actuated through torquing of the bolt head 160 (e.g. using a torque wrench) to a desired torque value or angular displacement. The sequence for each actuation cycle can include actuating the tensioning actuators 144 one at a time in a consecutive, sequential pattern in a circumferential direction (e.g. clockwise) about the vertical axis 106. In the example illustrated, the sequence for each incremental actuation cycle includes torquing the bolt head 160 of an initial tension rod 142 and moving in the circumferential direction to the next bolt head 160 of a circumferentially adjacent tension rod 142 until all of the bolt heads 160 have been torqued.

In some cases, it may be necessary or desirable to transfer loading between components of the apparatus 100 while the apparatus 100 is bearing the structural load. Referring to FIGS. 5B and 5C, in the example illustrated, this can be performed by lowering each tension rod 142 relative to the piston 124 one at a time into engagement with the base plate 112, to facilitate transfer of the structural load from the ram 122 to the base plate 112 through the compression portion of the tension rod 142 extending between the piston 124 and the base plate 112. This can help unload the tension portion of the tension rods 142, the top wall 118, and the sidewall 114 to, for example, permit the structural load to be transferred through compression rather than tension, and/or to facilitate maintenance and/or replacement of components (e.g. the load cells mounted to the sidewall).

In the example illustrated, each tension rod 142 can be disengaged from the structural load temporarily for lowering of the tension rod 142 into engagement with the base plate 112 one at a time, while the remaining tension rods 142 continue to take up the structural load. This can be done by partially unscrewing the tension rod 142 from the piston 124 (e.g. by rotating the bolt head 160 in an unscrewing direction) to raise the bolt head 160 off the spacer 162, removing the spacer 162 from under the bolt head 160 to permit lowering of the tension rod 142 to take up the vertical clearance 166 between the bottom end 164 and the base plate 112, and then screwing the tension rod 142 back towards the piston 124 (e.g. by rotating the bolt head 160 in a screwing direction opposite the unscrewing directing) until the bottom end 164 of the tension rod 142 is brought into engagement with the base plate 112.

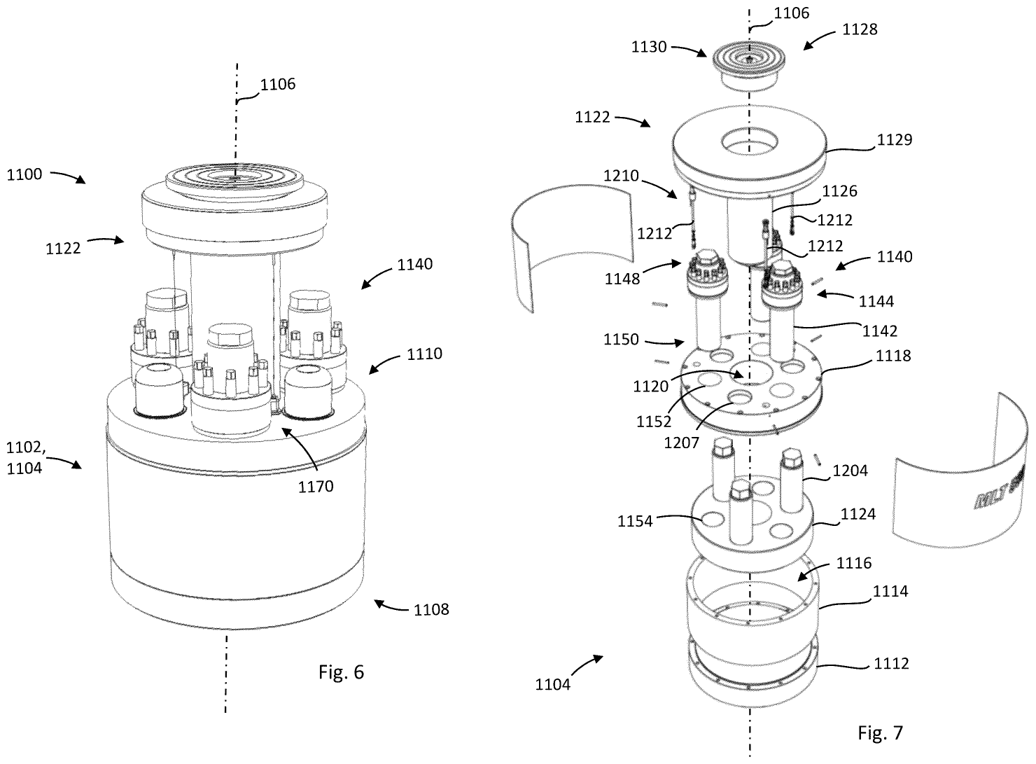

Referring to FIG. 6, another example load transfer apparatus is shown. The load transfer apparatus 1100 has similarities to the apparatus 100, and like features are identified with like reference numerals, incremented by 1000.

In the example illustrated, the apparatus 1100 includes a load-bearing frame 1102 defining a base of the apparatus 1100. In the example illustrated, the base comprises a housing 1104 extending along a vertical axis 1106 between a first end 108 and a second end 110. When the housing 1104 is upright, the first end 1108 comprises a lower end of the housing 1104 and the second end 1110 comprises an upper end of the housing 1104 above the lower end.

Referring to FIG. 7, in the example illustrated, the housing 1104 has a first (base) plate 1112 at the first, lower end 1108 for supporting the apparatus 1100 upright, a vertical support 1114 extending upwardly from the first plate 1112 along the vertical axis 1106, and a second plate 1118 supported by the vertical support 1114 at the second, upper end 1110 of the housing 1104 and through which an opening 1120 passes coaxial with the vertical axis 1106. In the example illustrated, the first plate 1112 defines a base plate of the housing 1104, the second plate 1118 defines a top wall of the housing 1104, and the vertical support 1114 defines a sidewall horizontally enclosing an interior 1116 of the housing 1104 and in the form of a cylindrical barrel.

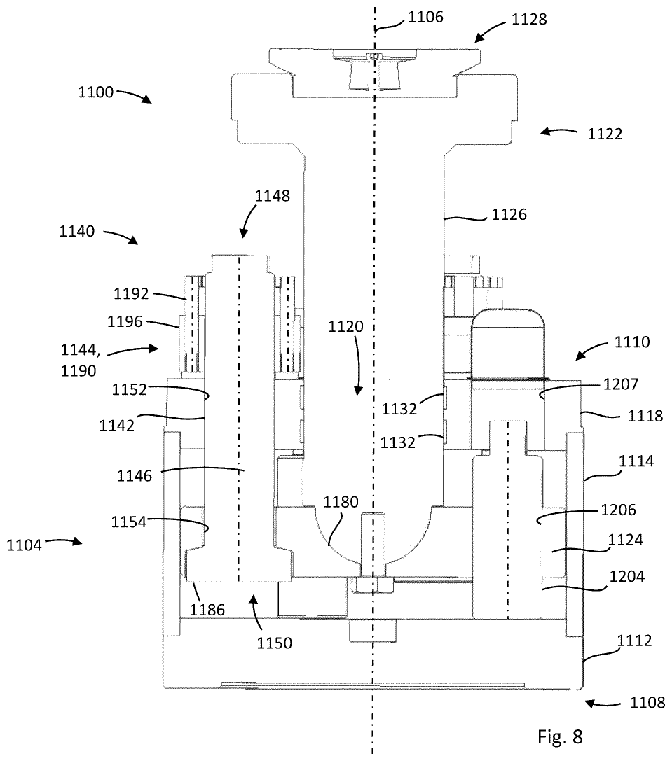

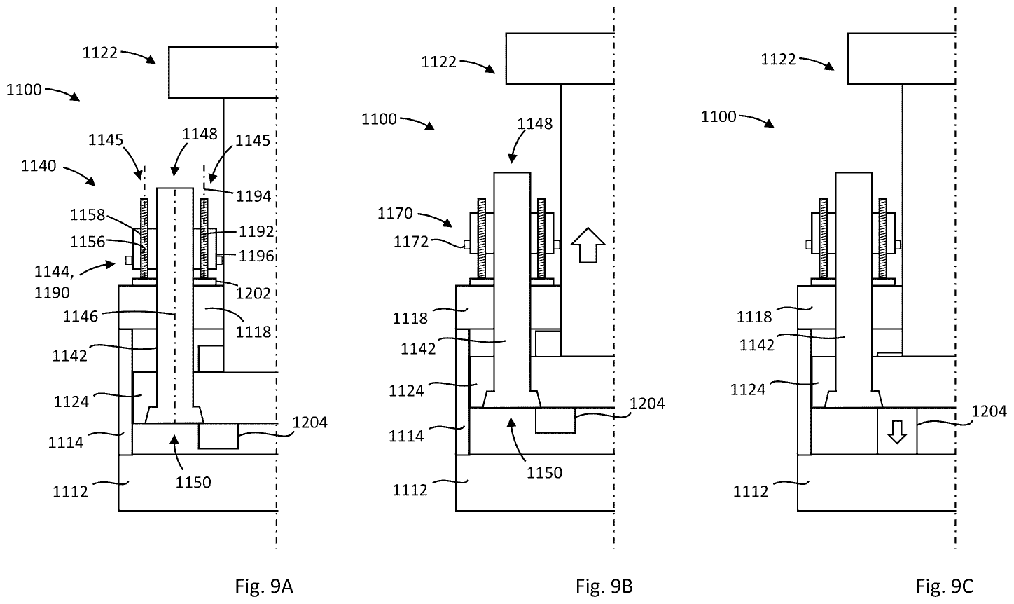

In the example illustrated, the apparatus 1100 includes a ram 1122 extending along the vertical axis 1106 and slidably mounted to the housing 1104 for vertical translation between a retracted position (FIG. 9A) and an advanced position (FIG. 9B). The ram 1122 includes a flange 1124 (also referred to as an intermediate plate 1124). In the example illustrated, the flange 1124 is in the form of a piston in the interior 1116 vertically intermediate the base plate 1112 and top wall 1118. In the example illustrated, the ram 1122 further includes a ram rod 1126 projecting upwardly from the piston 1124 along the vertical axis 1106 through the opening 1120 to an upper (rod) end 1128 (also referred to as upper end 1128) of the ram 1122 above the housing 1104. In the example illustrated, the upper end 1128 comprises a ram plate 1129 projecting radially outwardly relative to the ram rod 1126 and having a swivel plate 1130 rotatably mounted thereatop coaxial with and rotatable about the vertical axis 1106. Referring to FIG. 8, in the example illustrated, the ram rod 1126 extends through the opening 1120 of the top wall 1118 in close sliding fit. One or more top wall bushings 1132 are mounted in the opening 1120 for sliding engagement with the ram rod 1126 to facilitate the close sliding fit.

In the example illustrated, the ram rod 1126 is supported atop an upper surface of the piston 1124 in a ball-and-yoke interface 1180 to accommodate limited tilting of the ram 1122 relative to the vertical axis 1106. In the example illustrated, the upper surface of the piston 1124 has a generally hemispherical socket in alignment with the vertical axis 1106 and the rod 1126 has a hemispherical bottom end nested in the socket in close fit.

In the example illustrated, the apparatus 1100 further includes an integrated actuator assembly 1140 for translating the ram 1122 between the retracted and advanced positions. In the example illustrated, the actuator assembly 1140 includes a plurality of actuator rods. In the example illustrated, the actuator rods comprise a plurality of tension rods 1142 spaced circumferentially apart from each other about the ram rod 1126 and extending vertically between and coupling the piston 1124 and the top wall 1118. In the example illustrated, the actuator assembly 1140 further includes a plurality of mechanical actuators integrated with respective tension rods 1142. In the example illustrated, the plurality of mechanical actuators comprises a plurality of mechanical tensioning actuators 1144. Each tensioning actuator 1144 is operable to exert a tensioning force across a respective tension rod 1142 for pulling the piston 1124 towards the top wall 1118, to urge the ram 1122 toward the advanced position for exerting a lifting force on the structure with the rod end 1128 to transfer the structural load to the support surface through the apparatus 1100.

In the example illustrated, the plurality of tension rods 1142 are spaced equally apart from each other about the ram rod 1126 (and vertical axis 1106), and the actuator assembly 1140 includes three tension rods 1142. Each tension rod 1142 extends vertically along a respective rod axis 1146 through the top wall 1118, between an upper portion 1148 of the tension rod 1142 projecting upwardly from the top wall 1118 and a lower portion 1150 of the tension rod 1142 coupled to the piston 1124.

Referring to FIG. 7, in the example illustrated, the top wall 1118 has a plurality of top wall apertures 1152 extending through the top wall 1118, and the piston 1124 has a plurality of first piston apertures 1154 extending through the piston 1124 in horizontal alignment with respective top wall apertures 1152. In the example illustrated, each tension rod 1142 extends slidably through a respective top wall aperture 1152 for positioning the upper portion 1148 of the tension rod 1142 above the top wall 1118, and through a respective first piston aperture 1154 for coupling the lower portion 1150 of the tension rod 1142 to the piston 1124.

Referring to FIG. 8, in the example illustrated, each tension rod 1142 is slidably received through the top wall 1118 for vertical translation relative to the top wall 1118. The lower portion 1150 of each tension rod 1142 is vertically fixed relative to the piston 1124. The tensioning actuator 1144 is operable to urge the upper portion 1148 of the tension rod 1142 upwardly relative to the top wall 1118 for exerting the tensioning force across the tension rod 1142 to urge the piston 1124 upwardly toward the top wall 1118. In the example illustrated, a lower head 1186 is fixed to and projects radially outwardly from the lower portion 1150 of the tension rod 1142. Each first piston aperture 1154 has a countersink on the underside of the piston 1124. The lower head 1186 of the tension rod 1142 is received in the countersink for vertically anchoring the lower portion 1150 of the tension rod 1142 to the piston 1124.

Referring to FIG. 9A, in the example illustrated, each tensioning actuator 1144 comprises a screw actuator having a plurality of screw mechanisms 1145 for exerting the tensioning force. In the example illustrated, each screw mechanism 1145 comprises a first threaded component 1156 vertically fixed relative to the tension rod 1142 and in threaded engagement with a second threaded component 1158 vertically fixed relative to the housing 1104 during actuation.

In the example illustrated, each tensioning actuator 1144 comprises a multi-jackbolt tensioner 1190 coupling the upper portion 1148 of the tension rod 1142 to the top wall 1118. In the example illustrated, each multi-jackbolt tensioner 1190 includes the plurality of the screw mechanisms 1145 for exerting the tensioning force. In the example illustrated, each multi-jackbolt tensioner 1190 includes a plurality of jack bolts 1192 spaced circumferentially apart from each other about the upper portion 1148 of the tension rod 1142. Each jack bolt has external threading defining the second threaded component 1158. Each multi-jackbolt tensioner 1190 can include at least five jack bolts 1192, and in some examples, includes at least eight jack bolts 1192.

In the example illustrated, each multi-jackbolt tensioner 1190 includes a tensioner head 1196 (also referred to as a tensioner nut body) fixed to the upper portion 1148 of the tension rod 1142 during actuation (e.g. through threading of the tensioner head 1196 onto the upper portion 1148 of the tension rod). The tensioner head 1196 extends radially outwardly from the upper portion 1148 of the tension rod 1142 overtop of the top wall 1118. In the example illustrated, the tensioner head 1196 includes a central bore through which the upper portion 1148 extends in threaded engagement, and plurality of apertures extending vertically through the tensioner head 1196 radially outward of the central bore and spaced circumferentially apart from each other about the tension rod 1142. Each aperture has internal threading defining the first threaded component 1156.

In the example illustrated, each jack bolt 1192 extends vertically through a respective aperture in the tensioner head 1196, with the external threading of the jack bolt 1192 in threaded engagement with the internal threading in the aperture. Each jack bolt 1192 extends along a respective jack bolt axis 1194 parallel with the rod axis 1146 and is rotatable about the jack bolt axis 1194 to urge the tensioner head 1196 (and the upper portion 1148 of the tension rod 1142) upwardly away from the top wall 1118.

In the example illustrated, each jack bolt 1192 has a bottom end below the tensioner head 1196 and positioned atop the top wall 1118, and a top end above the tensioner head 1196. The top end of each jack bolt 1192 comprises a jack-bolt head for rotating the jack bolt 1192. In the example illustrated, a hardened washer 1202 extends about the tension rod 1142 vertically between the plurality of jack bolts 1192 and an upper surface of the top wall 1118. The bottom ends of the plurality of jack bolts 1192 are supported atop the washer 1202 for engagement with the top wall 1118.

Referring to FIG. 8, in the example illustrated, the apparatus 1100 further includes a plurality of compression rods 1204 in the interior of the housing 1104 and coupled to the piston 1124. In the example illustrated, each compression rod 1204 comprises a stud bolts extending vertically through the piston 1124 in threaded engagement with the piston 1124. Referring to FIGS. 9A and 9B, the compression rods 1204 are spaced vertically above the base plate 1112 during movement of the ram 1122 toward the advanced position for transferring loading from the ram 1122 to the top wall 1118 through tensioning of the tension rods 1142. Referring to FIGS. 9B and 9C, in the example illustrated, when the ram 1122 is in the advanced position, each compression rod 1204 is movable downwardly relative to the piston 1124 and into engagement with the housing base plate 1112 to transfer loading from the ram 1122 to the base plate 1112 through compression of the compression rods 1204 to facilitate unloading of the tension rods 1142, the top wall 1118, and the sidewall 1114. This can help to, for example, facilitate component maintenance and/or otherwise have the compression rods 1204 take up the structural load in place of the tension rods 1142.

Referring to FIG. 7, in the example illustrated, the plurality of compression rods 1204 are spaced circumferentially apart from each other about the vertical axis 1106, and extend parallel with and are circumferentially interspersed between the tension rods 1142. Each compression rod 1204 is in threaded engagement with the piston 1124 for raising and lowering the compression rod 1204 relative to the piston 1124 through rotation of the compression rod 1204 relative to the piston 1124. Referring to FIG. 8, in the example illustrated, the piston 1124 has a plurality of second piston apertures 1206 extending vertically through the piston 1124 and circumferentially interspersed between the first piston apertures 1154. Each compression rod 1204 is received in a respective second piston aperture 1206 in threaded engagement to facilitate raising and lowering of the compression rod 1204 through rotation of the compression rod 1204 about its axis relative to the piston 1124. In the example illustrated, the top wall 1118 has a plurality of access openings 1207 extending vertically therethrough in alignment with respective compression rods 1204 (and second piston apertures 1206). Each access opening 1207 provides access to a head of a respective compression rod 1204 to permit rotation (actuation) of the compression rod 1204 and raising/lowering of the compression rod 1204 relative to the piston 1124.

Referring to FIG. 6, in the example illustrated, the apparatus 1100 further includes an integrated load sensor system 1170 for measuring the structural load being transferred through the apparatus 1100. Referring to FIG. 9B, in the example illustrated, the load sensor system 1170 includes a plurality of load cells 1172 spaced equally apart from each other about the vertical axis 1106 for measuring loading at respective circumferential locations on the apparatus 1100 for determining the structural load. In some examples, this can also facilitate determining side loading exerted on the apparatus 1100 based on, for example, a measured differential between respective load cells 1172. In the example illustrated, each load cell 1172 is integrated with a respective actuator 1144 for measuring a tension load of a respective tension rod 1142. In the example illustrated, a respective load cell 1172 is integrated with each multi-jackbolt tensioner 1190. In the example illustrated, the load cell 1172 is integrated with the tensioner head 1196 (e.g. nut body) for measuring loading on the tensioner head 1196 (which can be indicative of loading on the respective tension rod 1142). In some examples, the load cell can comprise a strain gauge (sensor) extending about a circumference of the tensioner head 1196 (nut body) and operable to measure variation of a circumference of the tensioner head 1196, which can be indicative of the tensioning load of the tension rod 1142. Alternatively, or in addition, a load cell can be integrated with the hardened washer 1202 (e.g. in the form of a piezoelectric load cell positioned underneath the washer 1202) for measuring compressive loading exerted on the washer by the jack bolts 1192.

Referring to FIG. 7, in the example illustrated, the apparatus 1100 further includes an integrated displacement sensor system 1210 including one or more displacement sensors 1212 mounted to the apparatus 1100 for measuring vertical displacement of the ram 1122 relative to the housing 1104. In the examples illustrated, the displacement sensor system 1210 includes a plurality of the displacement sensors 1212 coupled to the ram 1122. The displacement sensors 1212 are positioned radially outward of the opening 1120 and spaced equally apart from each other about the vertical axis 1106 for measuring vertical displacement of respective circumferential locations of the ram 1122. This can allow for measurement of a vertical displacement differential between respective circumferential locations and detection and/or determination of tilting of the ram 1122 relative to the vertical axis 1106 (e.g. during actuation of a tension rod 1142) based on the displacement differential. In the example illustrated, each displacement sensor 1212 is circumferentially adjacent a respective tension rod 1142, for measuring displacement from actuation of the adjacent tension rod 1142. In the example illustrated, each displacement sensor 1212 has a first, lower end fixed relative to the housing 1104 (e.g. the top wall 1118) and a second, upper end 1216 fixed relative to the ram 1122 (e.g. an underside of the ram plate at the rod end 1128). Each displacement sensor can comprises, for example, a linear displacement transducer operable to generate a displacement signal indicative of the relative vertical displacement between the upper and lower ends of the displacement sensor 1212 for determining the vertical displacement of the ram 1122 at the respective circumferential locations relative to the housing 1104.

Referring to FIGS. 9A and 9B, in operation, the apparatus 1100 is positioned between the support surface and the structure with the ram 1122 in the lowered position. The actuator assembly 1140 is operated to urge the ram 1122 toward the advanced position to exert a lifting force on the structure for transfer of the structural load to the support surface through the apparatus 1100. In the example illustrated, operating the actuator assembly 1140 includes actuating the plurality of tensioning actuators 1144 one at a time sequentially during one or more actuation cycles. In the example illustrated, each tensioning actuator 1144 is actuated through torquing of each jack bolt 1192 of a respective multi-jackbolt tensioner 1190 sequentially (e.g. using a torque wrench) by a desired angular displacement and/or to a desired torque value, and then repeating the same process for each remaining tensioning actuator 1144. If further displacement of the ram 1122 is required after an initial actuation cycle, then one or more subsequent actuation cycles are performed to again actuate each tensioning actuator 1144 one at a time sequentially.

Referring to FIGS. 9B and 9C, in some cases, it may be necessary or desirable to transfer loading between components of the apparatus 1100 while the apparatus 1100 continues to bear the structural load (e.g. for component maintenance, replacement, inspection, etc.). In the example illustrated, this can be performed when the ram 1122 is in the advanced position by lowering the compression rods 1204 relative to the piston 1124 one at a time into engagement with the base plate 1112, to facilitate unloading of the tension rods 1142 and transfer of the structural load from the ram 1122 to the base plate 1112 through the compression rods 1204. In some examples, it may be necessary or desirable to unload a single tension rod 1142, in which case the pair of compression rods 1204 on circumferentially opposite sides of the tension rod 1142 can be lowered into engagement with the base plate 1112 to unload the tension rod 1142 (while the remaining tension rods 1142 continue to take up a portion of the structural load).

In other examples, the lower portion of each tension rod can be vertically fixed relative to the piston, and each tensioning actuator can comprise external threading extending about the rod axis along the upper portion of the tension rod in threaded engagement with internal threading vertically fixed relative to the top wall for urging the piston upwardly through relative rotation of the external and internal threading. In some examples, the tension rod can be rotated about its axis relative to internal threading fixed relative to the top wall (e.g. formed in the top wall apertures). In other examples, a nut with the internal threading can be rotated relative to the external threading on the tension rod to draw the tension rod upwardly through the nut relative to the top wall.

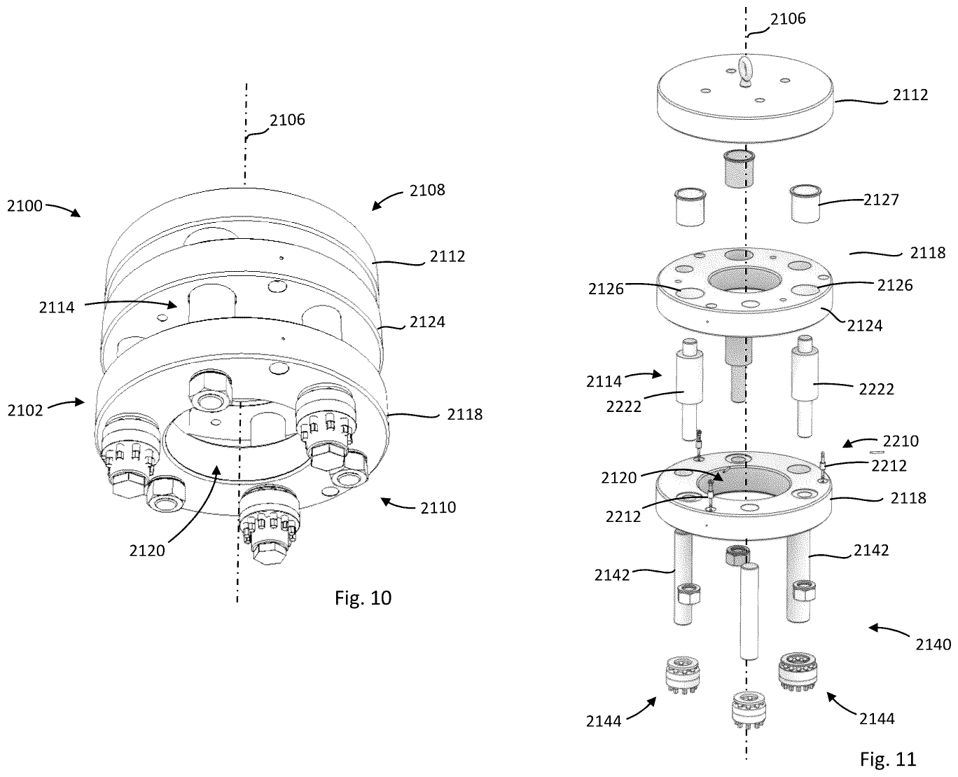

Referring to FIG. 10, another example load transfer apparatus 2100 is shown. The apparatus 2100 has similarities with the apparatus 1100, and like features are identified using like reference numerals, incremented by 1000.

In the example illustrated, the apparatus 2100 includes a load-bearing frame 2102 (defining a base) extending along a vertical axis 2106 between a first end 2108 and a second end 2110 vertically opposite the first end 2108. When the apparatus 2100 is in use, the first end 2108 defines an upper end of the frame 2102 and the second end 2110 defines a lower end of the frame 2102 below the upper end. In the example illustrated, the frame 2102 includes a first plate 2112 at the first, upper end 2108 for engagement with the structure, a second plate 2118 at the second, lower end 2110 and having an opening 2120 coaxial with the vertical axis 2106 for receiving a support surface through the opening 2120, and a vertical support 2114 positioned about the opening 2120 and extending along the vertical axis 2106 between and coupling the first and second plates 2112, 2118. Referring to FIG. 13A, in the example illustrated, the support surface 2012 comprises a building pile 2014 anchored in and projecting upwardly from a ground surface, and the opening 2120 is sized for receiving a top of the building pile 2014 therethrough. In the example illustrated, the apparatus 2100 is configured for mounting to a 12-inch pile top.

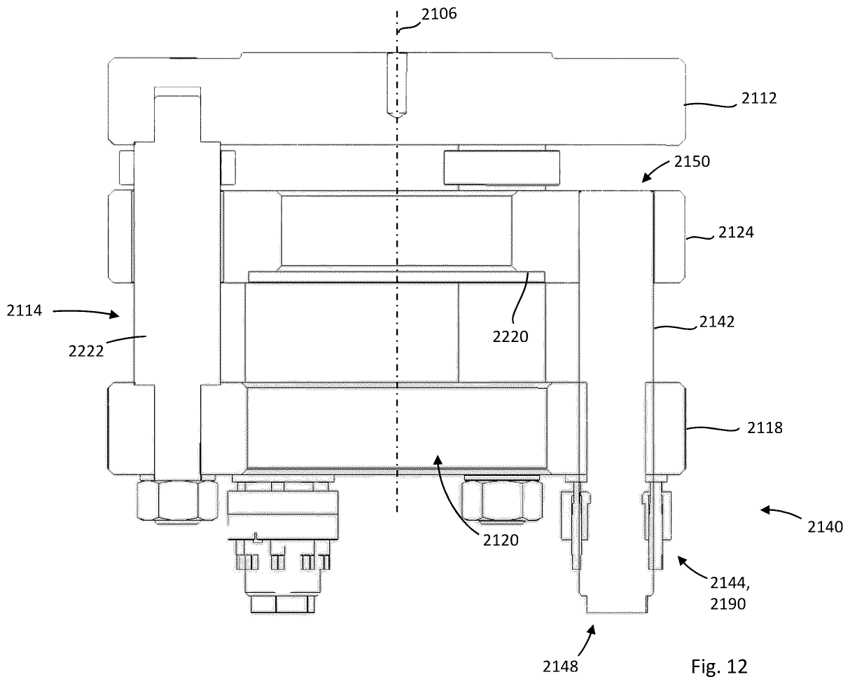

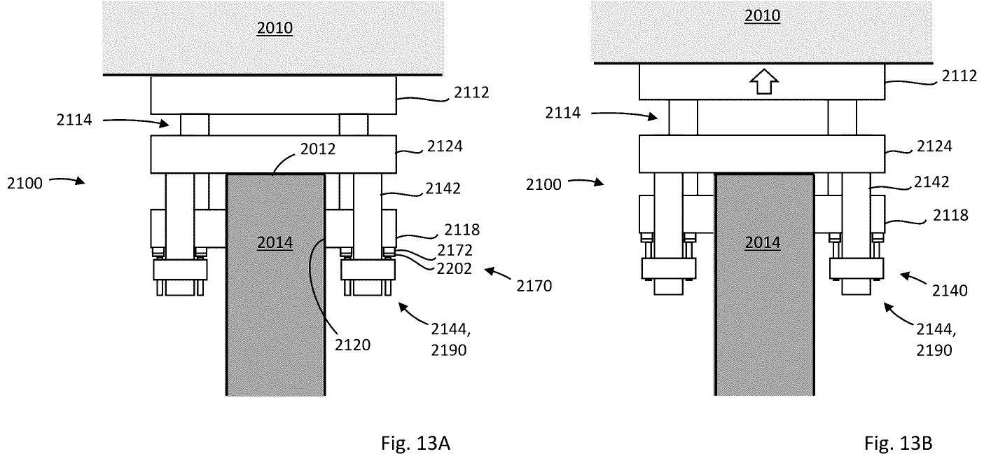

Referring to FIGS. 10 and 11, in the example illustrated, the apparatus 2100 includes an intermediate plate 2124 slidably mounted to the frame 2102 vertically intermediate the first and second plates 2112, 2118 for translation along the vertical axis 2106. In the example illustrated, the intermediate plate 2124 is positionable atop the building pile 2014 (FIG. 13A) when the building pile 2014 is received through the opening 2120. Referring to FIG. 12, in the example illustrated, the intermediate plate 2124 has an engagement surface 2220 on an underside of the intermediate plate 2124 facing the opening 2120. The engagement surface 2220 comprises a recess coaxial with the vertical axis 2106 and sized and shaped for receiving an upper end of the building pile 2014 (FIG. 13A).

Referring to FIG. 11, in the example illustrated, the vertical support 2114 comprises a plurality of pillars 2222 (three, in the example illustrated) spaced circumferentially apart from each other about the opening 2120. In the example illustrated, the intermediate plate 2124 has a plurality of mounting apertures 2126 through which respective pillars 2222 extend for slidably mounting the intermediate plate 2124 to the frame 2102 (e.g. through bushings 2227 received in the apertures 2126).

In the example illustrated, the apparatus 2100 includes integrated actuator assembly 2140 for urging the second plate 2118 toward the intermediate plate 2124 to raise the frame 2102 relative to the building pile. In the example illustrated, the actuator assembly 2140 includes a plurality of actuator rods. In the example illustrated, the actuator rods comprise a plurality of tension rods 2142 spaced circumferentially apart from each other about the opening 2120 and extending vertically between and coupling the intermediate plate 2124 and the second plate 2118. The actuator assembly 2140 further includes a plurality of mechanical actuators integrated with respective tension rods 2142. In the example illustrated, the plurality of mechanical actuators comprises a plurality of mechanical tensioning actuators 2144. Referring to FIGS. 13A and 13B, each tensioning actuator 2144 is operable to exert a tensioning force across a respective tension rod 2142 for urging the intermediate plate 2124 from a retracted position (FIG. 13A) to an advanced position (FIG. 13B) relative to the frame 2102. With the intermediate plate 2124 supported atop the building pile 2014, this pulls the second plate 2118 upwardly toward the intermediate plate 2124, to exert a lifting force on the structure 2010 with the frame 2102 for transfer of the structural load to the building pile 2014 through the apparatus 2100.

In the example illustrated, the plurality of tension rods 2142 are spaced equally apart from each other about the opening 2120 (and vertical axis 2106), and the actuator assembly 2140 includes three tension rods 2142 (see FIG. 11). Referring to FIG. 12, in the example illustrated, each tension rod 2142 extends vertically along a respective rod axis slidably through the second plate 2118, between a lower portion 2148 of the tension rod 2142 projecting downwardly from an underside of the second plate 2118, and an upper portion 2150 of the tension rod 2142 coupled to the intermediate plate 2124.

In the example illustrated, the upper portion 2150 of each tension rod 2142 is vertically fixed relative to the intermediate plate 2124, and the tensioning actuator 2144 is operable to urge the second plate 2118 upwardly relative to the lower portion 2148 of the tension rod 2142 for exerting the tensioning force across the tension rod 2142 between the lower portion and the intermediate plate. In the example illustrated, each tensioning actuator 2144 comprises a multi-jackbolt tensioner 2190 coupling the lower portion 2148 of the tension rod 2142 to the second plate 2118 for urging the second plate 2118 upwardly relative lower portion 2148 of the tension rod 2142 to urge the second plate 2118 toward the intermediate plate 2124.

Referring to FIG. 1, in the example illustrated, the apparatus 2100 includes an integrated displacement sensor system 2210 including one or more displacement sensors 2212 mounted to the apparatus 2100 for measuring vertical displacement of the intermediate plate 2124 relative to the frame 2102. In the examples illustrated, the displacement sensor system 2210 includes a plurality of the displacement sensors 2212 (three, in the example illustrated) extending vertically and coupled between the intermediate plate 2124 and the second plate 2118. The displacement sensors 2212 are positioned radially outward of the opening 2120 and spaced equally apart from each other about the vertical axis 2106 for measuring vertical displacement of respective circumferential locations of the second plate 2118 relative to the intermediate plate 2124 (e.g. to allow for determining tilting based on displacement differential between respective circumferential locations).

In some examples, the apparatus 2100 can include a load sensor system for measuring the structural load being transferred through the apparatus 2100, and which can be similar to that described above with respect to the apparatus 1100. Referring to FIG. 13A, in the example illustrated, the apparatus 2100 is shown to include a load sensor system 2170 having a plurality of load cells (load sensors) 2172 spaced equally apart from each other about the vertical axis 2106 for measuring loading at respective circumferential locations on the apparatus 2100 for determining the structural load. In the example illustrated, each load cell 2172 is integrated with a respective actuator 2144 for measuring a tension load of a respective tension rod 2142. In the example illustrated, a respective load cell 2172 is integrated with each multi-jackbolt tensioner 2190. In the example illustrated, each load cell 2172 is integrated with the washer 2202 of the tensioner 2190 (e.g. in the form of a piezoelectric load cell positioned vertically between the washer 2202 and the second plate 2118) for measuring compressive loading exerted by the tensioner 2190 (which can be indicative of the loading on the respective tension rod 2142).

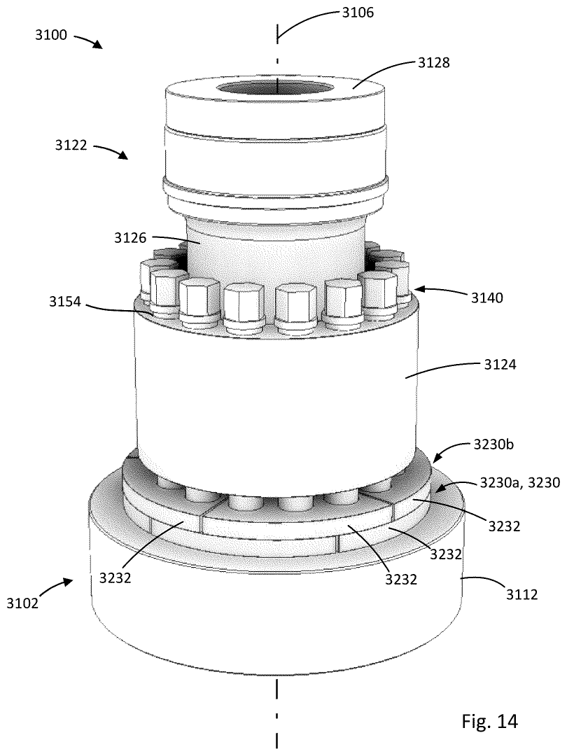

Referring to FIG. 14, another example load transfer apparatus is shown. The load transfer apparatus 3100 has similarities to the apparatus 100, and like features are identified with like reference numerals, incremented by 3000.

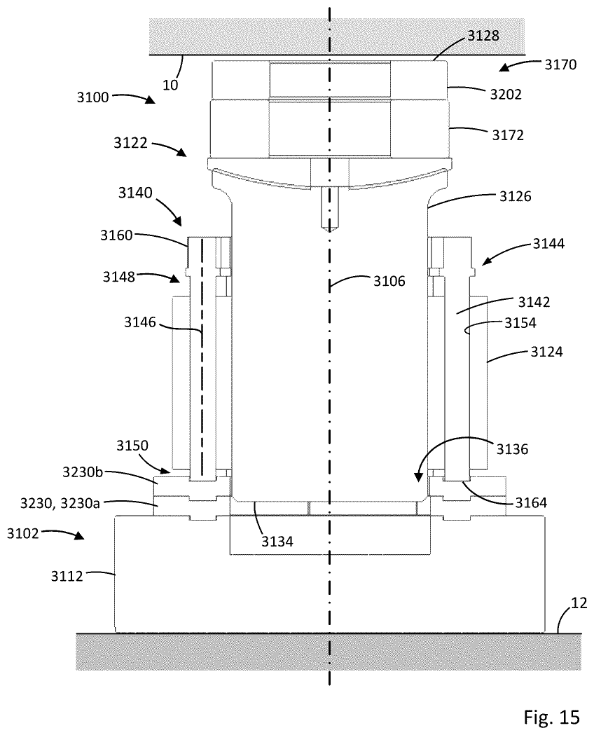

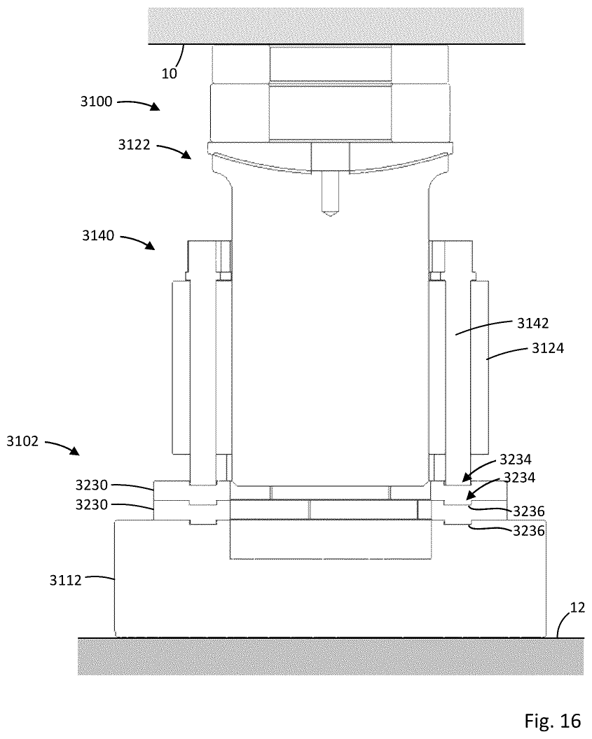

Referring to FIG. 15, in the example illustrated, the load transfer apparatus 3100 includes a base 3102 positionable on a support surface 12 for supporting the apparatus 3100 upright. The apparatus 3100 further includes a ram 3122 supported by the base 3102 (through the actuator assembly 3140, in the example illustrated) and projecting upwardly relative to the base 3102 along a vertical axis 3106 to an upper end 3128 of the ram 3122 for engagement with a structure 10. In the example illustrated, the apparatus 3100 further includes a mechanical actuator assembly 3140 coupling the ram 3122 to the base 3102. The mechanical actuator assembly 3140 is operable to urge the ram 3122 upwardly relative to the base 3102 along the vertical axis 3106 to exert a lifting force for transferring the structural load to the support surface 12 through the apparatus 3100. In the example illustrated, the ram 3122 is translatable along the vertical axis 3106 through operation of the actuator assembly 3140 between a retracted position (shown in FIG. 15) and an advanced position (shown in FIG. 16) above the retracted position.

In the example illustrated, the actuator assembly 3140 comprises a plurality of actuator rods 3142 spaced circumferentially apart from each other about the vertical axis 3106 and coupling the ram 3122 to the base 3102 for transfer of the structural load from the ram 3122 to the base 3102 through the plurality of rods 3142. In the example illustrated, the entire weight of the ram 3122 is borne by the rods 3142. In the example illustrated, the structural load is transferred from the ram 122 to the plurality of rods 3142, and from the plurality of rods 3142 under compression to the base 3102. The mechanical actuator assembly 3140 further includes a plurality of mechanical actuators 3144 integrated with respective rods 3142. Each actuator 3144 is operable independently of each other actuator 3144 for sequential loading of respective rods 3142 one-by-one to incrementally urge the ram upwardly. In the example illustrated, each actuator 3144 is operable to urge the ram 3122 upwardly along a respective rod 3142. In the example illustrated, each actuator comprises a screw actuator, and is operable to urge the ram 3122 upwardly along a respective rod 3142 through torquing of the rod 3142 about its axis relative to the ram 3122.

In the example illustrated, the ram 3122 includes a ram rod 3126 projecting upwardly away from the base 3102 along the vertical axis 3106 to the upper end 3128 of the ram 3122. In the example illustrated, the ram 3122 further includes a flange 3124 fixed to and projecting radially from the ram rod 3126 below the upper end 3128 of the ram 3122. In the example illustrated, the plurality of rods 3142 extend vertically between and couple the flange 3124 and the base 3102, and each mechanical actuator 3144 is operable to urge the flange 3124 upwardly along a respective rod 3142 for lifting the ram 3122. In the example illustrated, the flange 3124 comprises a nut (also referred to as a plate) and is threaded over an exterior of the ram rod 3126. In other examples, the flange 3124 can be formed integrally with the ram rod 3126.

In the example illustrated, the flange 3124 includes a plurality of apertures 3154 spaced circumferentially apart from each other about the vertical axis 3106 and extending vertically through the flange 3124. The plurality of rods 3142 extend vertically through respective apertures 3154. In the example illustrated, each actuator 3144 comprises external threading (first threaded component) extending about and along a respective rod 3142 and in engagement with internal threading (second threaded component) in a respective aperture 3154. Each rod 3142 extends vertically through a respective aperture 3154 along a respective rod axis 3146 between an upper portion 3148 above the flange 3124 and a lower portion 3150 below the flange 3124 and supported by the base 3102. In the example illustrated, the upper portion 3148 comprises a bolt head 3160 for torquing the rod 3142 about its rod axis 3146 relative to the flange 3124 to load the rod 3142 for urging the ram 3122 upwardly along the rod 3142 (via the threaded engagement between the rod 3142 and the flange 3124).

Still referring to FIG. 15, in the example illustrated, the ram 3122 has a guide shaft 3134 projecting downwardly from the flange 3124 opposite and coaxial with the ram rod 3126, and defining a lower end of the ram 3122. In the example illustrated, the base 3102 has an upper surface directed toward the ram 3122. In the example illustrated, the bottom ends 3164 of the rods 3142 are supported atop and in engagement with the upper surface of the base 3102. The base 3102 has a bore 3136 extending along the vertical axis 3106 and open to the upper surface. The bore 3136 receives the guide shaft 3134 of the ram 3122 in close, sliding fit, which can help to, for example, guide vertical translation, facilitate alignment, and increase side loading capacity of the ram 3122.

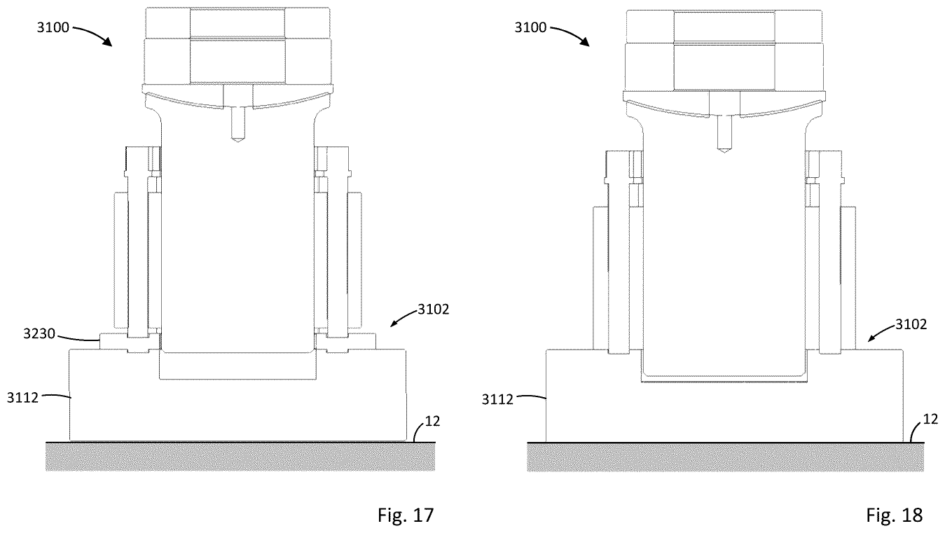

Referring to FIG. 15, in the example illustrated, the base 3102 includes a base plate 3112 over which the actuator assembly 3140 is positioned. In the example illustrated, the base 3102 further includes at least one optional extension plate 3230 removably mounted between the base plate 3112 and the actuator assembly 3140 for adjusting a height of the upper end 3128 of the ram 3122 relative to the base plate 3112 (and the support surface 12). In the example illustrated, the base 3102 is shown with two extension plates 3230 mounted to raise the upper end 3128 relative to the base plate 3112 by around the thickness of the extension plates 3230. In the example illustrated, the thickness of each extension plate 3230 is less than a maximum stroke of the actuator assembly 3140 to permit insertion of each extension plate 3230 as described in more detail below. Referring to FIG. 17, the base 3102 is shown with a single extension plate. Referring to FIG. 18, the base 3102 is shown with no extension plates. In other examples, additional extension plates 3230 can be provided, and the base 3102 can be built up to include, for example, three or more extension plates 3230 for further raising the ram 3122.

In the example illustrated, each extension plate 3230 comprises a plurality of separate plate sections 3232 spaced circumferentially apart from each other about the ram 3122. In the example illustrated, each extension plate 3230 comprises at least five identical plate sections. Each plate section 3232 is positionable vertically between the base plate 3112 and the bottom end 3164 of a respective set of rods 3142. As described further below, each plate section 3232 is insertable (and removable from) between the base 3102 and the respective set of rods 3142 to permit height adjustment of the ram 3122, without necessarily requiring removal of the ram 3122 and/or actuator assembly 3140 from the base 3102, and in some examples, while the structural load is being borne by and transferred through the apparatus.

Referring to FIG. 14, in the example illustrated, the base 3102 is shown to include a lower extension plate 3230a mounted atop the base plate 3112 and an upper extension plate 3230b mounted atop the lower extension plate 3230a. Each plate section 3232 of the upper extension plate 3230b extends circumferentially over and is supported by a pair of circumferentially adjacent plate sections 3232 of the lower extension plate 3230, which can facilitate stability and load distribution. Referring to FIG. 16, in the example illustrated, the base plate 3112 and each extension plate 3230 has a generally planar top surface and a plurality of recesses 3234 formed in the top surface. The plurality of recesses 3234 are spaced circumferentially apart from each other, and the bottom ends of the rods 3142 are nestable in respective recesses 3234 of either the uppermost extension plate 3230 or the base plate 3112 (e.g. if no extension plates 3230 are provided, as shown in FIG. 18). Each extension plate 3230 has an underside surface opposite the top surface and a plurality of pins 3236 projecting downwardly from the underside surface. The pins 3236 of each extension plate 3230 are insertable in respective recesses 3234 below the extension plate 3230 (e.g. of either the base plate 3112 or a lower extension plate 3230). The recesses 3234 and pins 3236 facilitate alignment of and inhibit relative lateral movement between the rods 3142, extension plates 3230, and base plate 3112.

Referring to FIG. 15, in the example illustrated, the apparatus 3100 further includes an integrated load sensor system 3170 for measuring the structural load being transferred through the apparatus 3100. In the example illustrated, the integrated load sensor system 3170 is integrated with the ram 3122, and includes a load cell 3172 adjacent the upper end 3128 of the ram 3122. In the example illustrated, a washer 3202 defining the upper end 3128 of the ram 3122 is positioned atop the load cell 3172, which can facilitate load distribution to and help protect components of the load cell 3172. In the example illustrated, the load cell 3172 comprises a transducer (e.g. in the form of strain gauge(s) or piezoelectric load cell(s)).

Referring to FIG. 15, in operation, the apparatus 3100 is positioned between the structure 10 and the support surface 12. The base 3102 of the apparatus 3100 is positioned on the support surface 12 and the upper end 3128 of the ram 3122 is positioned adjacent the structure 10. When the apparatus 3100 is in position, the actuator assembly 3140 is operated to urge the ram 3122 upwardly relative to the base 3102 to engage the structure 10 and transfer the structural load to the support surface 12 through the apparatus 3100. To operate the actuator assembly 3140, each mechanical actuator 3144 is actuated independently of each other mechanical actuator 3144 to sequentially load the plurality of respective rods 3142 one-by-one in a plurality of actuation cycles to incrementally raise the ram 3122 upwardly.

In the example illustrated, the plurality of mechanical actuators 3144 are spaced circumferentially apart from each other about the ram 3122. The sequence for each actuation cycle can include actuating the actuators 3144 one at a time in a consecutive, sequential pattern in a circumferential direction (e.g. clockwise or counterclockwise) about the vertical axis 3106. In the example illustrated, the sequence for each incremental actuation cycle includes torquing the bolt head 3160 of an initial rod 3142 and moving in the circumferential direction to the next bolt head 3160 of a circumferentially adjacent rod 3142 until all of the bolt heads 3160 have been torqued for that cycle (e.g. by a desired angular displacement and/or to a desired torque value). The process can be reversed to lower the ram 3122 downwardly relative to the base 3102 by sequentially untorquing the bolt heads 3160 one-by-one in a plurality of lowering cycles for disengaging the structure 10 to offload the structural load from the apparatus 3100.

In some examples, it may be necessary or desirable to adjust a height of the upper end 3128 of the ram 3122 relative to the base 3102 independently of the actuator assembly 3140, for example, where a maximum stroke of the actuator assembly 3140 is insufficient for the current ram position to adequately engage or further raise the structure. In such cases, one or more extension plates 3230 can be added (or removed if lowering of the ram 3122 is desired) to the base 3102. To add an extension plate 3230, each plate section 3232 of the extension plate 3230 is inserted one at a time. To insert a plate section 3232, the set of rods 3142 positionable over that plate section 3232 (e.g. three circumferentially adjacent rods 3142) are raised out of engagement with the base 3102 by unscrewing the set of rods 3142 relative to the flange 3124. The bottom ends 3164 of the set of rods 3142 are raised above the upper surface of the base 3102 by a height corresponding to the thickness of the plate section 3232 to permit insertion of the plate section 3232 between the upper surface of the base 3102 and the bottom ends 3164 of the set of rods 3142. The remaining rods 3142 (e.g. the remaining twelve circumferentially adjacent rods 3142) remain lowered into engagement with the base 3102 to continue supporting the actuator assembly 3140 and ram 3122 during insertion (or removal) of the plate section 3232. Once the plate section 3232 is inserted, the set of rods 3142 are lowered back down, into engagement with the inserted plate section 3232 (i.e. into respective recesses 3234 of the plate section), thereby resetting the available stroke of that set of rods 3142 by the thickness of the plate section 3232. The process can then be repeated for the remaining plate sections 3232 and respective sets of rods 3142 to install the extension plate 3230, and then repeated again for further extension plates 3230 as necessary.

A similar process can be performed to remove the extension plates 3230 to lower the ram 3122. This can include raising a respective set of rods 3142 out of engagement with and clear of the respective plate section 3232 to allow for its removal. The plate section 3232 can then be removed, and the set of rods 3142 can be lowered back down into engagement with the upper surface of the base 3102 below the removed plate section 3232 (e.g. into engagement with a lower extension plate 3230 or the base plate 3112). The process can then be repeated for each remaining plate section 3232, and for additional extension plates 3230 as necessary.

In some examples, the extension plate(s) 3230 can be added or removed prior to load transfer through the apparatus 3100 (e.g. to take up excess clearance between the upper end 3128 of the ram 3122 and the structure 10), or in some examples, while the structural load is being transferred through the apparatus 3100 (e.g. to reset the stroke of the actuator assembly 3140 to further raise the structure 10 during load transfer, or to lower the structure 10 during load structure). In the example illustrated, the apparatus 3100 includes fifteen rods 3142 and each extension plate 3230 includes five plate sections 3232, to provide for a set of three rods 3142 positionable over each plate section 3232. In such examples, when the set of three rods 3142 for any one plate section 3232 are raised out of engagement with the base 3102, a sufficient number of remaining rods 3142 (e.g. twelve) remain in engagement with the base 3102 about the axis 3106 to provide generally balanced support for the actuator assembly 3140 and ram 3122 and adequate load distribution from the ram 3122 to the base 3102 through the remaining rods 3142.

1. A high-capacity, mechanical load transfer apparatus for transferring a structural load of a structure, comprising:
a) a base positionable on a support surface for supporting the apparatus upright;
b) a ram supported by the base and projecting upwardly relative to the base along a vertical axis to an upper end of the ram for engagement with the structure; and
c) an integrated actuator assembly coupling the ram to the base and operable to urge the ram upwardly relative to the base along the vertical axis to exert a lifting force for transferring the structural load to the support surface through the apparatus, the actuator assembly comprising a plurality of rods spaced circumferentially apart from each other about the vertical axis and coupling the ram to the base for transfer of the structural load from the ram to the base through the plurality of rods, and a plurality of mechanical actuators integrated with respective rods, each actuator operable independently of each other actuator for sequentially loading respective rods one-by-one in a plurality of actuation cycles to incrementally urge the ram upwardly.

2. The apparatus of claim 1, wherein each actuator is operable to urge the ram upwardly along a respective rod.

3. The apparatus of claim 1, wherein each mechanical actuator comprises a screw actuator.

4. The apparatus of claim 1, wherein the ram includes a ram rod projecting upwardly from the base along the vertical axis to the upper end of the ram and a flange fixed to and projecting radially from the ram rod below the upper end of the ram, and wherein the plurality of rods extend vertically between and couple the flange and the base.

5. The apparatus of claim 4, wherein the flange includes a plurality of apertures spaced circumferentially apart from each other about the vertical axis and extending vertically through the flange, and wherein the plurality of rods extend vertically through respective apertures.

6. The apparatus of claim 5, wherein each actuator comprises external threading extending about a respective rod and in engagement with internal threading in a respective aperture.

7. The apparatus of claim 6, wherein each rod extends vertically through a respective aperture along a respective rod axis between an upper portion above the flange and a lower portion below the flange and supported by the base, the upper portion comprising a bolt head for torquing the rod about the rod axis relative to the flange to load the rod for urging the ram upwardly along the rod.

8. The apparatus of claim 1, wherein the base has a bore extending along the vertical axis below the actuator assembly, the bore receiving a lower end of the ram in close sliding fit.

9. The apparatus of claim 1, wherein the base comprises a base plate and at least one extension plate removably mountable between the base plate and the actuator assembly for adjusting an elevation of the upper end of the ram relative to the base plate.

10. The apparatus of claim 9, wherein each extension plate comprises a plurality of plate sections spaced circumferentially apart from each other about the ram, each plate section insertable and removable from vertically between the base plate and a bottom end of a set of respective rods of the plurality of rods when the set of rods are raised out of engagement with the base while the remaining rods of the plurality of rods remain lowered into engagement with the base.

11. The apparatus of claim 1, further comprising an integrated load sensor system for measuring the structural load being transferred through the apparatus.

12. The apparatus of claim 11, wherein the integrated load sensor system comprises a load cell integrated with the ram.

13. The apparatus of claim 1, wherein the actuator assembly comprises at least nine rods and respective actuators.

14. A method of transferring a structural load of a structure using a mechanical load transfer apparatus, the method comprising:
a) positioning the apparatus between the structure and a support surface, with a base of the apparatus positioned on the support surface and an upper end of a ram of the apparatus positioned adjacent the structure; and
b) operating an integrated actuator assembly of the apparatus to urge the ram upwardly relative to the base to engage the structure and transfer the structural load to the support surface through the apparatus, wherein operating the actuator assembly includes actuating a plurality of mechanical actuators of the actuator assembly independently of each other to sequentially load a plurality of respective rods coupling the ram and the base one-by-one in a plurality of actuation cycles for incrementally urging the ram upwardly.

15. A mechanical load transfer apparatus for transferring a structural load of a structure, comprising:
a) a load-bearing frame extending along a vertical axis between a first end and a second end, the frame including a first plate oriented normal to the axis at the first end for engagement with one of the structure and a support surface, a second plate oriented normal to the axis at the second end and having an opening coaxial with the vertical axis, and a vertical support positioned about the opening and extending vertically between and coupling the first and second plates;
b) an intermediate plate slidably mounted to the frame vertically intermediate the first and second plates for translation along the vertical axis therebetween, the intermediate plate for engagement with the other one of the structure and the support surface through the opening in the second plate; and
c) an integrated actuator assembly for urging the intermediate plate toward the second plate, the actuator assembly including: (i) a plurality of tension rods spaced circumferentially apart from each other about the vertical axis and extending vertically between and coupling the intermediate plate and the second plate, and (ii) a plurality of mechanical tensioning actuators integrated with respective tension rods, each tensioning actuator operable to exert a tensioning force across a respective tension rod to pull the intermediate plate towards the second plate to exert a lifting force on the structure relative to the support surface for transfer of the structural load to the support surface through the apparatus.

16. The apparatus of claim 15, wherein each tensioning actuator comprises a screw actuator.

17. The apparatus of claim 15, wherein each actuator comprises a multi-jackbolt tensioner coupling the tension rod to the second plate.

18. The apparatus of claim 15, further comprising an integrated load sensor system for measuring the structural load being transferred through the apparatus.

19. The apparatus of claim 18, wherein the load sensor system includes a plurality of load cells spaced apart from each other about the vertical axis for measuring loading at respective circumferential locations on the apparatus.

20. The apparatus of claim 15, further comprising an integrated displacement sensor system including one or more displacement sensors for measuring a vertical displacement of the intermediate plate relative to the frame.
